(19) United States
(12) Patent Application Publication
(10) Pub. No.: US 2012/0294370 A1
(43) Pub. Date: Nov. 22, 2012

(54) SYSTEM AND METHOD FOR LOW COMPLEXITY MOTION VECTOR DERIVATION

(76) Inventors: Yi-Jen Chiu, San Jose, CA (US); Lidong Xu, Beijing (CN); Wenhao Zhang, Beijing (CN)

(21) Appl. No.: 13/575,233

(22) PCT Filed: Apr. 1, 2011
(86) PCT No.: PCT/CN11/00568

§ 371 Date: Jul. 25, 2012

Related U.S. Application Data
(60) Provisional application No. 61/390,461, filed on Oct. 6, 2010.

(51) Int. Cl. H04N 7/32

(52) U.S. Cl. 375/240.16; 375/E07.104

(57) ABSTRACT

A system and method for performing candidate-based decoder-side motion vector determination (DMVD). Candidate motion vectors (MVs) may be rounded to the nearest whole or integer pixel. The rounded candidate MV having the best sum of absolute differences (SAD) may be identified. This may be used as the final MV. Alternatively, the un-rounded MV corresponding to this rounded candidate MV may be used as the final MV. Alternatively, a small range integer search may be performed around the chosen rounded candidate MV, and the best integer pixel in the search area may be identified and used to define the final MV. Alternatively, an intermediate MV may be chosen, where this MV is intermediate between the chosen rounded candidate MV and the MV corresponding to the best integer pixel in the search area.

### RELATED APPLICATIONS

This patent application is a U.S. National Phase application under 35 U.S.C. §371 of International Application No. PCT/CN2010/002107, filed Dec. 21, 2010, entitled SYSTEM AND METHOD FOR ENHANCED DMVD PROCESSING, which claims the benefit of U.S. Provisional Application No. 61/390,461, filed on Oct. 6, 2010, which is incorporated herein by reference in its entirety.

This patent application is also related to the following patent applications:

U.S. patent application Ser. No. 12/657,168, filed Jan. 14, 2010.

U.S. patent application Ser. No. 12/567,540, filed Sep. 25, 2009.

U.S. patent application Ser. No. 12/566,823, filed Sep. 25, 2009.

U.S. patent application Ser. No. 12/582,061, filed Oct. 20, 2009.

U.S. Provisional Application No. 61/364,565, filed on Jul. 15, 2010.

### BACKGROUND

In a traditional video coding system, motion estimation (ME) is performed at an encoder to get motion vectors for the prediction of motion for a current encoding block. The motion vectors may then be encoded into a binary stream and transmitted to the decoder. This allows the decoder to perform motion compensation for the current decoding block. In some advanced video coding standards, e.g., H.264/AVC, a macroblock (MB) can be partitioned into smaller blocks for encoding, and a motion vector can be assigned to each sub-partitioned block. As a result, if the MB is partitioned into 4×4 blocks, there may be up to 16 motion vectors for a predictive coding MB and up to 32 motion vectors for a bi-predictive coding MB, which may be significant overhead. Considering that the motion coding blocks have very strong temporal and spatial correlations, motion estimation may be performed based on reconstructed reference pictures or reconstructed spatially neighboring blocks at the decoder side. This may let the decoder derive the motion vectors itself for the current block, instead of receiving motion vectors from the encoder. This decoder-side motion vector derivation (DMVD) method may increase the computational complexity of the decoder, but it can improve the efficiency of an existing video codec system by saving bandwidth.

Motion estimation at the decoder side may require a search among possible motion vector candidates in a search window. The search may be an exhaustive search or may rely on a fast search algorithm. Even if a fast search algorithm is used, a considerable number of candidates may have to be evaluated before the best candidate is found. This too represents an inefficiency in processing at the decoder side. Simulation results show that the DMVD complexity may still be very high at the decoder side even if candidates-based DMVD is used.

### BRIEF DESCRIPTION OF THE DRAWINGS/FIGURES

FIG. 1 is a block diagram of a video encoder system, according to an embodiment.

FIG. 2 is a block diagram of a video decoder system, according to an embodiment.

FIG. 3 is a diagram illustrating mirror motion estimation (ME) at a decoder, according to an embodiment.

FIG. 4 is a diagram illustrating projective ME at a decoder, according to an embodiment.

FIG. 5 is a diagram illustrating spatial neighbor block ME at a decoder, according to an embodiment.

FIG. 6 is a diagram illustrating temporal collocated block ME at a decoder, according to an embodiment.

FIG. 7 is a diagram illustrating spatially neighboring blocks for motion vector prediction, according to an embodiment.

FIG. 8 is a flowchart illustrating the use of pixel interpolation, according to an embodiment.

FIG. 9 is a flowchart illustrating the derivation of a motion vector, according to an embodiment.

FIG. 10 is a flowchart illustrating the derivation of a motion vector, according to an additional embodiment.

FIG. 11 is a flowchart illustrating the derivation of a motion vector, according to an additional embodiment.

FIG. 12 is a flowchart illustrating the derivation of a motion vector, according to an additional embodiment.

FIG. 13 is a block diagram illustrating a computing environment for a software or firmware embodiment.

### DETAILED DESCRIPTION

An embodiment is now described with reference to the enclosed figures. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Disclosed herein are methods and systems to enhance processing at the decoder in a video compression/decompression system.

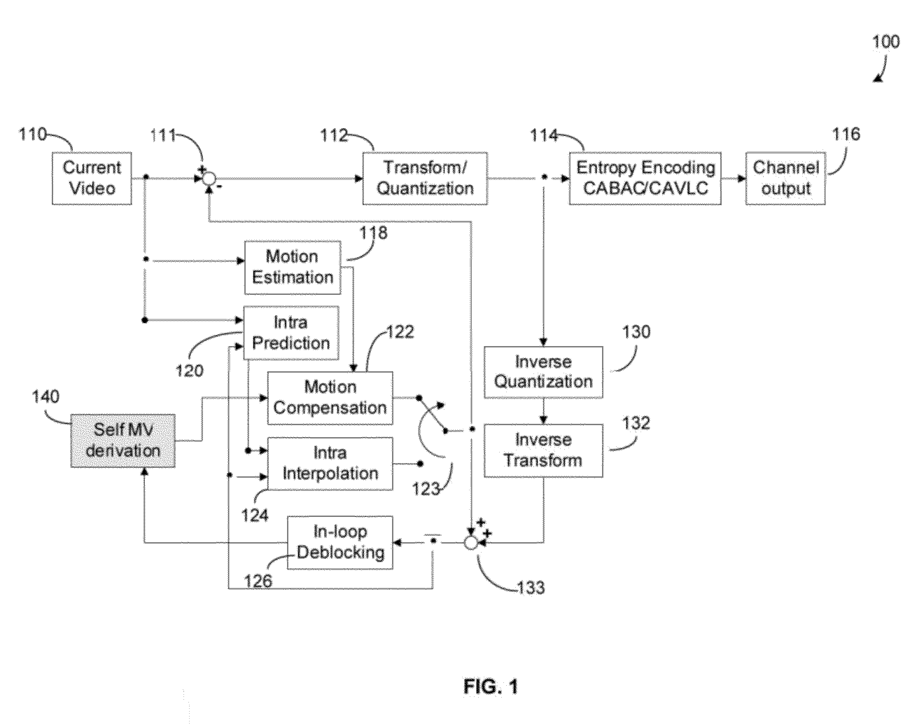

The enhanced processing described herein may take place in the context of a video encoder/decoder system that implements video compression and decompression, respectively. FIG. 1 illustrates an exemplary H.264 video encoder architecture 100 that may include a self MV derivation module 140, where H.264 is a video codec standard. Current video information may be provided from a current video block 110 in a form of a plurality of frames. The current video may be passed to a differencing unit 111. The differencing unit 111 may be part of the Differential Pulse Code Modulation (DPCM) (also called the core video encoding) loop, which may include a motion compensation stage 122 and a motion estimation stage 118. The loop may also include an intra prediction stage 120, and intra interpolation stage 124. In some cases, an in-loop deblocking filter 126 may also be used in the loop.

The current video may be provided to the differencing unit 111 and to the motion estimation stage 118. The motion compensation stage 122 or the intra interpolation stage 124 may produce an output (through a switch 123) that may then be subtracted from the current video 110 to produce a residual. The residual may then be transformed and quantized at transform/quantization stage 112 and subjected to entropy encoding in block 114. A channel output results at block 116.

The output of motion compensation stage 122 or intra-interpolation stage 124 may be provided to a summer 133 that may also receive an input from inverse quantization unit 130 and inverse transform unit 132. These latter two units may undo the transformation and quantization of the transform/quantization stage 112. The inverse transform unit 132 may provide dequantized and detransformed information back to the loop.

A self MY derivation module 140 may implement processing for derivation of a motion vector from previously decoded pixels. Self MV derivation module 140 may receive the output of in-loop deblocking filter 126, and may provide an output to motion compensation stage 122.

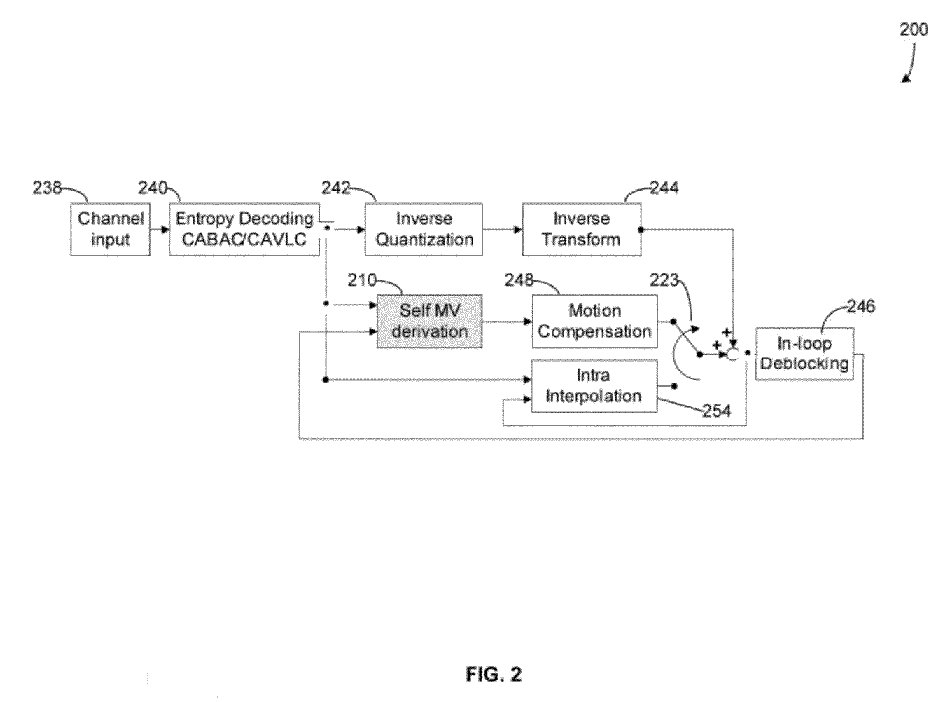

FIG. 2 illustrates an H.264 video decoder 200 with a self MV derivation module 210. Here, a decoder 200 associated with the encoder 100 of FIG. 1 may include a channel input 238 coupled to an entropy decoding unit 240. The output from the decoding unit 240 may be provided to an inverse quantization unit 242 and an inverse transform unit 244, and to self MV derivation module 210. The self MV derivation module 210 may be coupled to a motion compensation unit 248. The output of the entropy decoding unit 240 may also be provided to intra interpolation unit 254, which may feed a selector switch 223. The information from the inverse transform unit 244, and either the motion compensation unit 248 or the intra interpolation unit 254 as selected by the switch 223, may then be summed and provided to an in-loop de-blocking unit 246 and fed back to intra interpolation unit 254. The output of the in-loop deblocking unit 246 may then be fed to the self MV derivation module 210.

The self MV derivation module at the encoder may synchronize with the video decoder side. The self MV derivation module could alternatively be applied on a generic video codec architecture, and is not limited to the H.264 coding architecture.

The encoder and decoder described above, and the processing performed by them as described above, may be implemented in hardware, firmware, or software, or some combination thereof. In addition, any one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

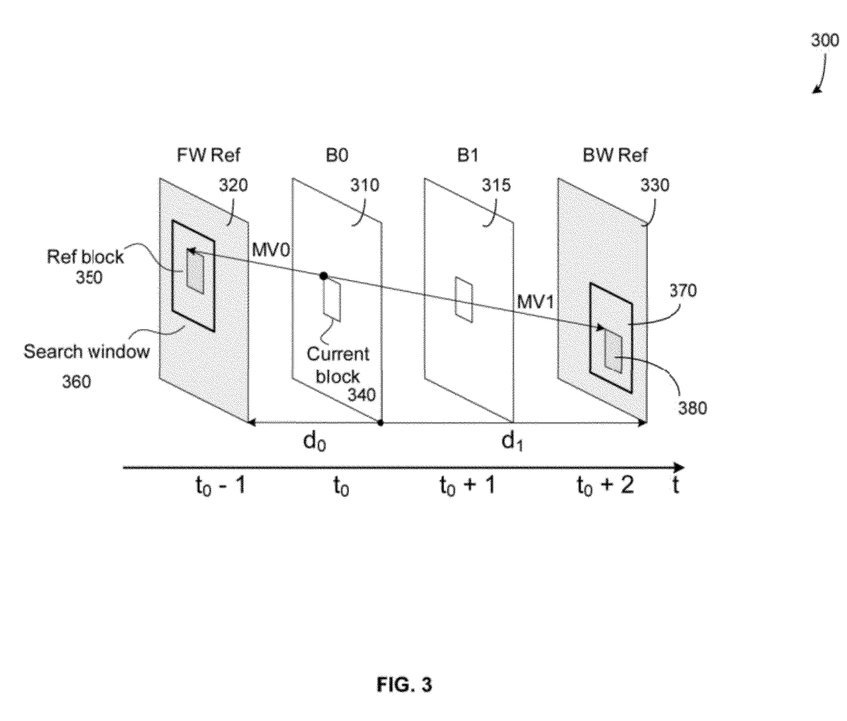

Decoder side motion estimation (ME) may be based on the assumption that the motions of a current coding block may have strong correlations with those of its spatially neighboring blocks and those of its temporally neighboring blocks in reference pictures. FIG. 3-FIG. 6 show different decoder side ME methods which may employ different kinds of correlations.

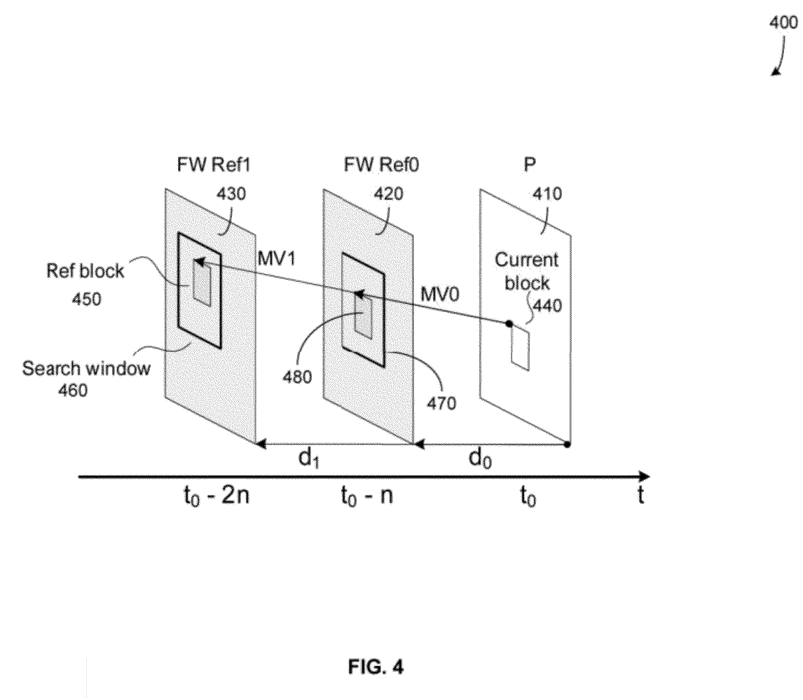

Mirror ME in FIG. 3 and projective ME in FIG. 4 may be performed between two reference frames by employing the temporal motion correlation. In the embodiment of FIG. 3, there may be two bi-predictive frames (B frames), 310 and 315, between a forward reference frame 320 and a backward reference frame 330. Frame 310 may be the current encoding frame. When encoding the current block 340, mirror ME can be performed to get motion vectors by performing searches in search windows 360 and 370 of reference frames 320 and 330, respectively. As mentioned above, where the current input block may not be available at the decoder, mirror ME may be performed with the two reference frames.

FIG. 4 shows an exemplary projective ME process 400 that may use two forward reference frames, forward (FW) Ref0 (shown as reference frame 420) and FW Ref1 (shown as reference frame 430). These reference frames may be used to derive a motion vector for a current target block 440 in a current frame P (shown as frame 410). A search window 470 may be specified in reference frame 420, and a search path may be specified in search window 470. For each motion vector MV0 in the search path, its projective motion vector MV1 may be determined in search window 460 of reference frame 430. For each pair of motion vectors, MV0 and its associated motion vector MV1, a metric, such as a sum of absolute differences (SAD), may be calculated between (1) the reference block 480 pointed to by the MV0 in reference frame 420, and (2) the reference block 450 pointed to by the MV1 in reference frame 430. The motion vector MV0 that yields the optimal value for the metric, e.g., the minimal SAD, may then be chosen as the motion vector for target block 440.

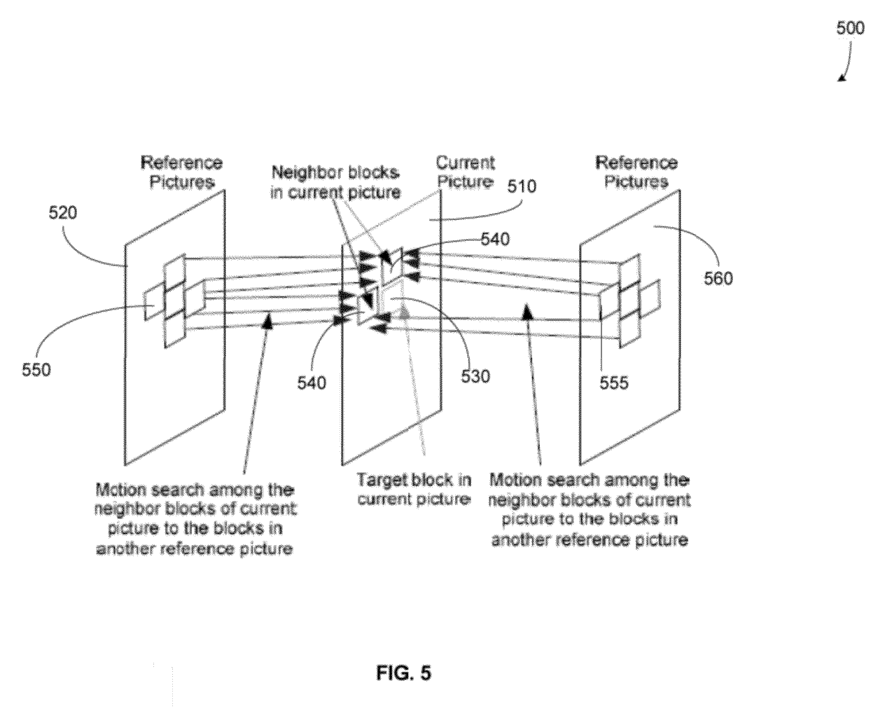

To improve the accuracy of the output motion vectors for a current block, some implementations may include the spatial neighboring reconstructed pixels in the measurement metric of decoder side ME. In FIG. 5, decoder side ME may be performed on the spatially neighboring blocks by taking advantage of spatial motion correlation. FIG. 5 shows an embodiment 500 that may utilize one or more neighboring blocks 540 (shown here as blocks above and to the left of the target block 530) in a current picture (or frame) 510. This may allow generation of a motion vector based on one or more corresponding blocks 550 and 555 in a previous reference frame 520 and a subsequent reference frame 560, respectively, where the terms “previous” and “subsequent” refer to temporal order. The motion vector can then be applied to target block 530. In an embodiment, a raster scan coding order may be used to determine spatial neighbor blocks above, to the left, above and to the left, and above and to the right of the target block. This approach may be used for B frames, which use both preceding and following frames for decoding.

The approach exemplified by FIG. 5 may be applied to available pixels of spatially neighboring blocks in a current frame, as long as the neighboring blocks were decoded prior to the target block in sequential scan coding order. Moreover, this approach may apply motion search with respect to reference frames in reference frame lists for a current frame.

The processing of the embodiment of FIG. 5 may take place as follows. First, one or more blocks of pixels may be identified in the current frame, where the identified blocks neighbor the target block of the current frame. Motion search for the identified blocks may then be performed, based on corresponding blocks in a temporally subsequent reference frame and on corresponding blocks in a previous reference frame. The motion search may result in motion vectors for the identified blocks. Alternatively, the motion vectors of the neighboring blocks may be determined prior to identification of those blocks. The motion vectors may then be used to derive the motion vector for the target block, which may then be used for motion compensation for the target block. This derivation may be performed using any suitable process known to persons of ordinary skill in the art. Such a process may be, for example and without limitation, weighted averaging or median filtering.

If the current picture has both backward and forward reference pictures in the reference buffer, the same method as used for mirror ME may be used to get the picture level and block level adaptive search range vectors. Otherwise, if only forward reference pictures are available, the method described above for projective ME may be used to get the picture level and block level adaptive search range.

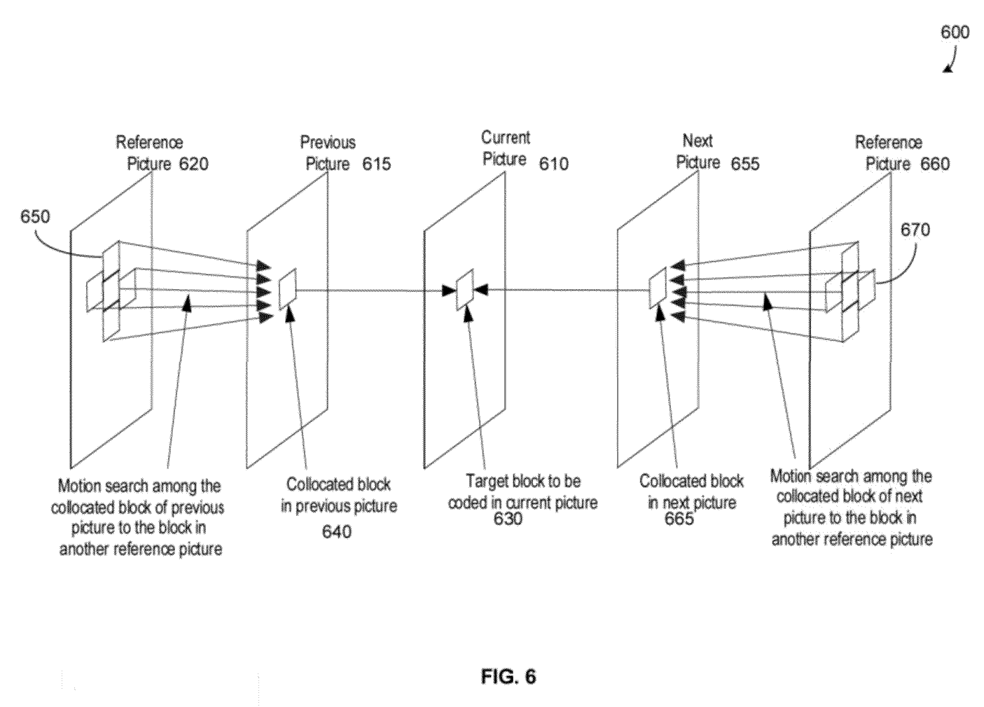

The corresponding blocks of previous and succeeding reconstructed frames, in temporal order, may be used to derive a motion vector. This approach is illustrated in FIG. 6. To encode a target block 630 in a current frame 610, already decoded pixels may be used, where these pixels may be found in a corresponding block 640 of a previous picture, shown here as frame 615, and in a corresponding block 665 of a next frame, shown as picture 655. A first motion vector may be derived for corresponding block 640, by doing a motion search through one or more blocks 650 of a reference frame, picture 620. Block(s) 650 may neighbor a block in reference frame 620 that corresponds to block 640 of previous picture 615. A second motion vector may be derived for corresponding block 665 of next frame 655, by doing a motion search through one or more blocks 670 of reference picture, i.e., frame 660. Block(s) 670 may neighbor a block in reference picture 660 that corresponds to block 665 of next frame 655. Based on the first and second motion vectors, forward and/or backward motion vectors for target block 630 may be determined. These latter motion vectors may then be used for motion compensation for the target block.

The ME processing for such a situation may be as follows. A block may first be identified in a previous frame, where this identified block may correspond to the target block of the current frame. A first motion vector may be determined for this identified block of the previous frame, where the first motion vector may be defined relative to a corresponding block of a first reference frame. A block may be identified in a succeeding frame, where this block may correspond to the target block of the current frame. A second motion vector may be determined for this identified block of the succeeding frame, where the second motion vector may be defined relative to the corresponding block of a second reference frame. One or two motion vectors may be determined for the target block using the respective first and second motion vectors above. Analogous processing may take place at the decoder.

When encoding/decoding the current picture, the block motion vectors between the previous frame 615 and the reference frame 620 may be available. Using these motion vectors, the picture level adaptive search range can be determined in the manner described above for projective ME. The motion vectors of the corresponding block and blocks that spatially neighbor the corresponding block can be used to derive the block level adaptive search range as in the case of mirror ME.

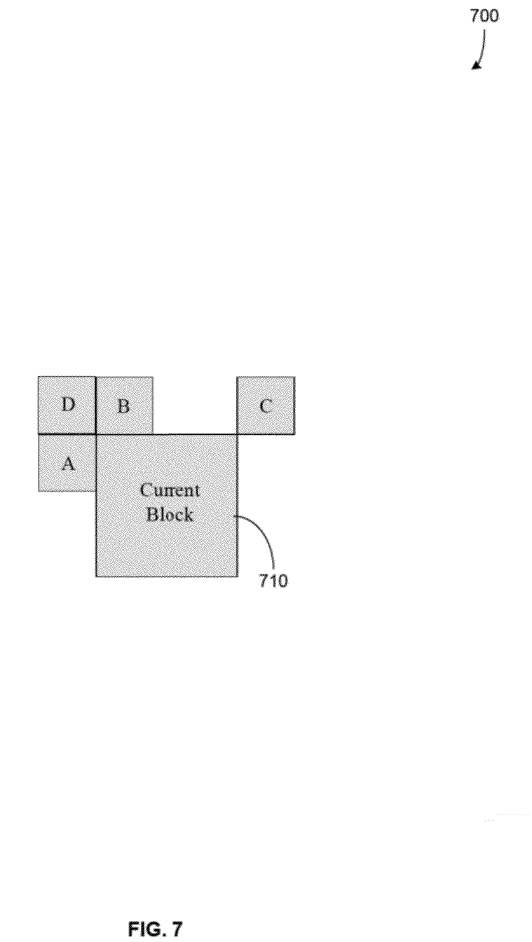

Candidates based ME can be performed to reduce the ME complexity at the decoder side, and the encoder and decoder should use the same candidates to avoid any mismatch. Candidate motion vectors can be zero MVs and the MVs derived from the motion vectors of the coded spatial neighboring blocks and coded temporal neighboring blocks. For example, as shown in FIG. 7, the MVs of the spatial neighbor blocks A-E can be used as candidates if they are available, and the median filtered MVs of blocks A-E can also be used as candidates. To get more accurate MVs, the candidate motion vectors can be refined by performing a small range motion search around them, and the encoder and decoder should use the same refining scheme. Refinements may then be applied. For example, all candidate motion vectors may be checked. The candidate motion vector with the minimum sum of absolute differences (SAD) may be selected. A small range motion search may then be performed around this best candidate in order to determine the final motion vector. Alternatively, a small range motion search may be performed around each candidate motion vector. This leads to a corresponding set of refined candidates. The refined candidate having the minimum SAD may then be used as the final motion vector.

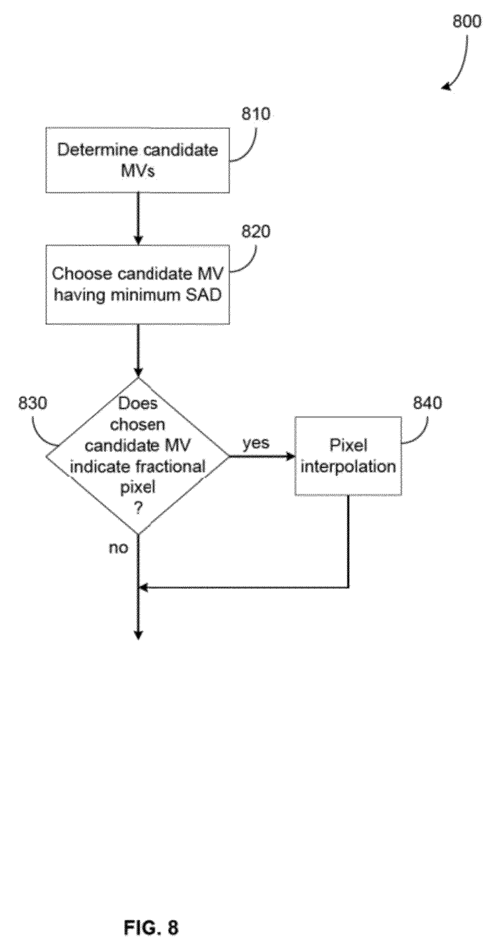

Additional variations exist for candidate-based DMVD. In an embodiment, all candidate motion vectors may be checked, and the one with minimum SAD may be used as the final derived MV. In this way, it may be the case that no subsequent refining process is performed. Note that the resulting motion vector may indicate a fractional pixel, and pixel interpolation would be needed to produce the pixel values for calculating the SAD. This is illustrated in FIG. 8. At 810, a group of candidate motion vectors may be determined. At 820, the candidate having the minimum SAD may be chosen. At 830, a determination may be made as to whether the chosen candidate motion vector indicates a fractional pixel. If so, then at 840, pixel interpolation may be performed.

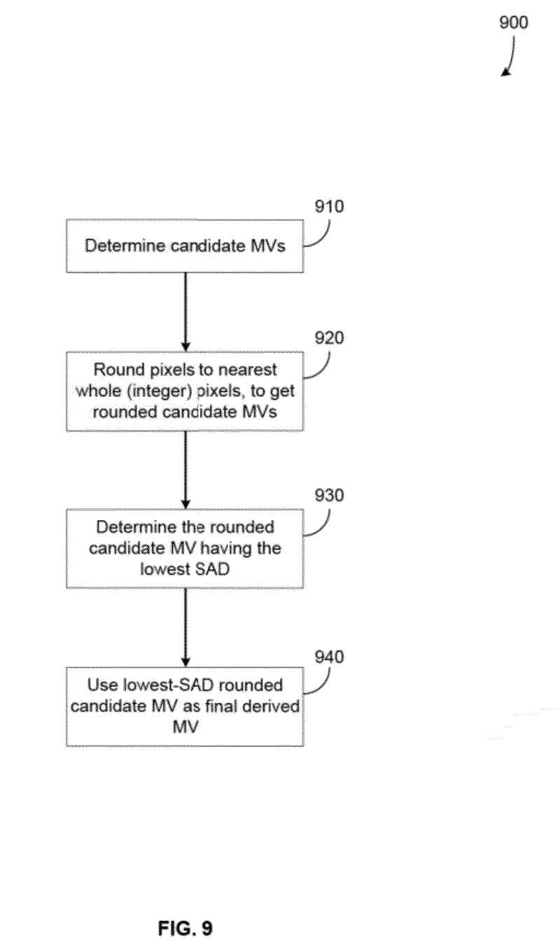

The complexities of pixel interpolation may be avoided in an embodiment, where the candidate motion vectors may be forced to integer pixel positions by rounding them to the nearest whole pixels. The rounded candidate motion vectors may then be checked, and the one with minimum SAD may be used as the final derived MV. In this way, pixel interpolation may not be necessary and decoding complexity can be reduced. This is illustrated in FIG. 9, according to an embodiment. At 910, the candidate motion vectors may be determined. At 920, the pixels identified by these candidate motion vectors may be rounded to the nearest whole pixels. Such pixels may be viewed as integer pixels, given that they result from the rounding of fractional values. The resulting motion vectors may be described as rounded candidate motion vectors. At 930, the rounded candidate motion vector having the lowest SAD may be determined. At 940, this lowest-SAD rounded candidate motion vector may be used as the final derived motion vector.

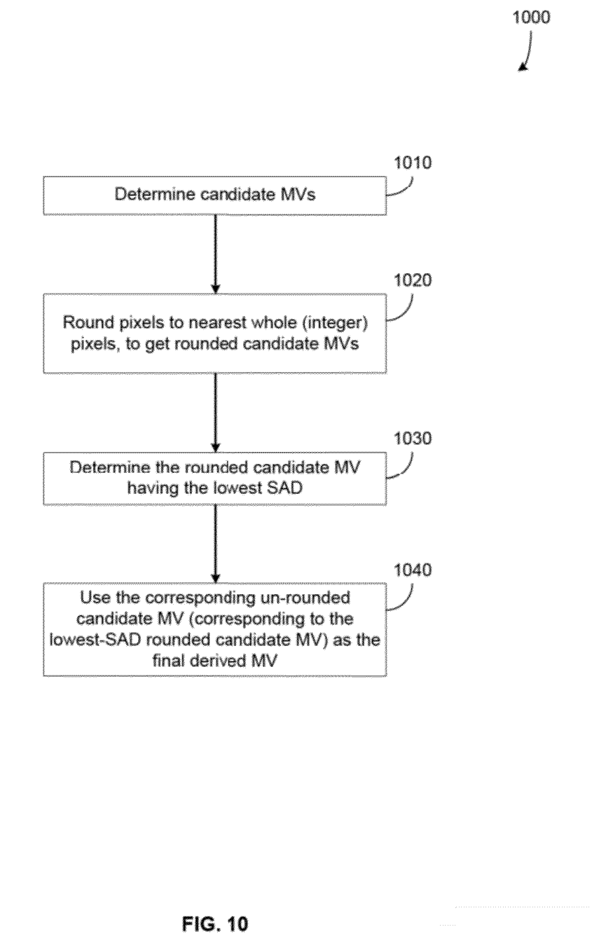

In an alternative embodiment, the candidate motion vectors may be forced to integer pixel positions by rounding them to the nearest whole pixels. Then all the rounded motion vectors may be checked, and the rounded candidate motion vector having the best (i.e., lowest) SAD may be identified. The original un-rounded MV corresponding to this best rounded candidate MV may be used as the final derived MV. This alternative does not increase the ME complexity and provides for greater MV precision. Such an embodiment is illustrated in FIG. 10. At 1010, candidate motion vectors may be determined. At 1020, the pixels corresponding to the candidate motion vectors may be rounded to the nearest whole (integer) pixels, resulting in rounded candidate motion vectors. At 1030, the rounded candidate motion vector having the lowest SAD may be determined. At 1040, the original un-rounded candidate motion vector that corresponds to the lowest-SAD rounded candidate motion vector may be used as the final derived motion vector.

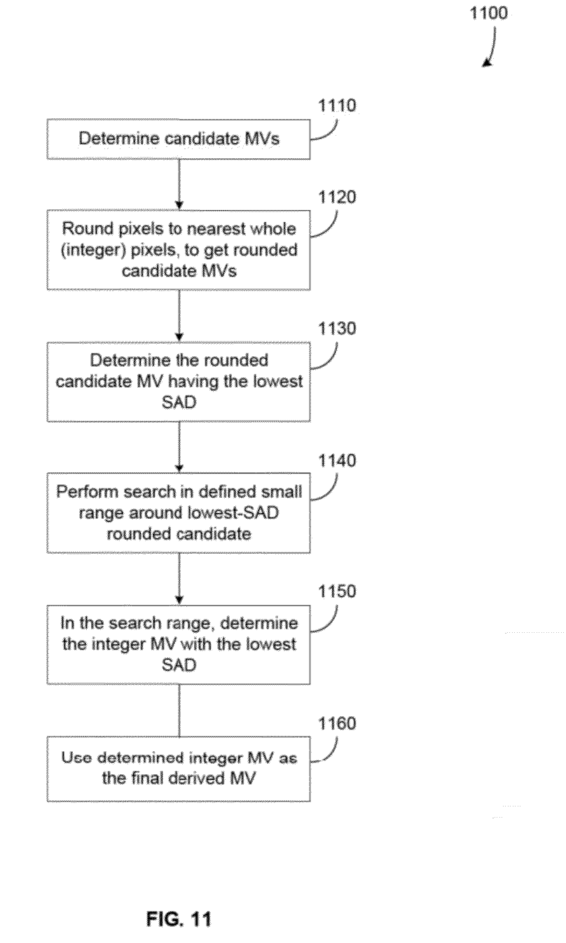

In another alternative, after identifying the best rounded candidate, a small range integer pixel refinement ME around the best rounded candidate may be performed. The best refined integer MV resulting from this search may then be used as the final derived MV. Since the refinement ME may be performed on the integer pixel, no interpolation operation may be needed and the decoding complexity increase may not be significant. Such an embodiment is illustrated in FIG. 11. At 1110, the candidate motion vectors may be determined. At 1120, the pixels corresponding to the candidate motion vectors may be rounded to the nearest whole pixels, resulting in rounded candidate motion vectors. At 1130, the rounded candidate motion vector having the lowest SAD may be determined. At 1140, a search may be performed in a small range defined around the lowest-SAD rounded candidate. At 1150, within this search range, the integer motion vector with the lowest SAD may be determined. At 1160, this determined integer motion vector may be used as the final derived motion vector.

In an alternative embodiment, after performing small range integer pixel refinement ME and obtaining the best refined integer MV as described in the previous embodiment, an intermediate position may be used, e.g., a middle position, between the best refined integer MV and the best rounded candidate. The vector corresponding to this intermediate position may then be used as the final derived MV. This embodiment may not increase the ME complexity but can provide for enhanced precision.

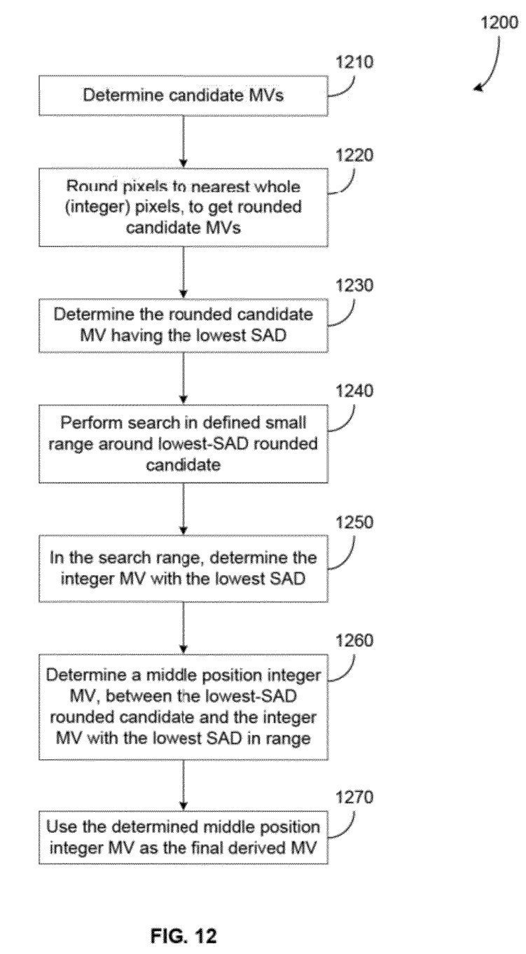

This embodiment is illustrated in FIG. 12. At 1210, the candidate motion vectors may be determined. At 1220, the pixels corresponding to the candidate motion vectors may be rounded to the nearest whole (integer) pixels, resulting in rounded candidate motion vectors. At 1230, the rounded candidate motion vector having the lowest SAD may be determined. At 1240, a search may be performed in a small range defined around the lowest-SAD rounded candidate. At 1250, within this search range, the integer motion vector with the lowest SAD may be determined. At 1260, a middle position integer motion vector may be determined, between the lowest-SAD rounded candidate and the integer motion vector with the lowest SAD in the search range, the latter having been identified at 1250. This middle position integer motion vector may be the integer motion vector closest to the average of the two, in an embodiment. Alternatively, the middle position motion vector may be the average of the lowest-SAD rounded candidate and the integer motion vector with the lowest SAD in the search range, where this middle position motion vector indicates a fractional pixel.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

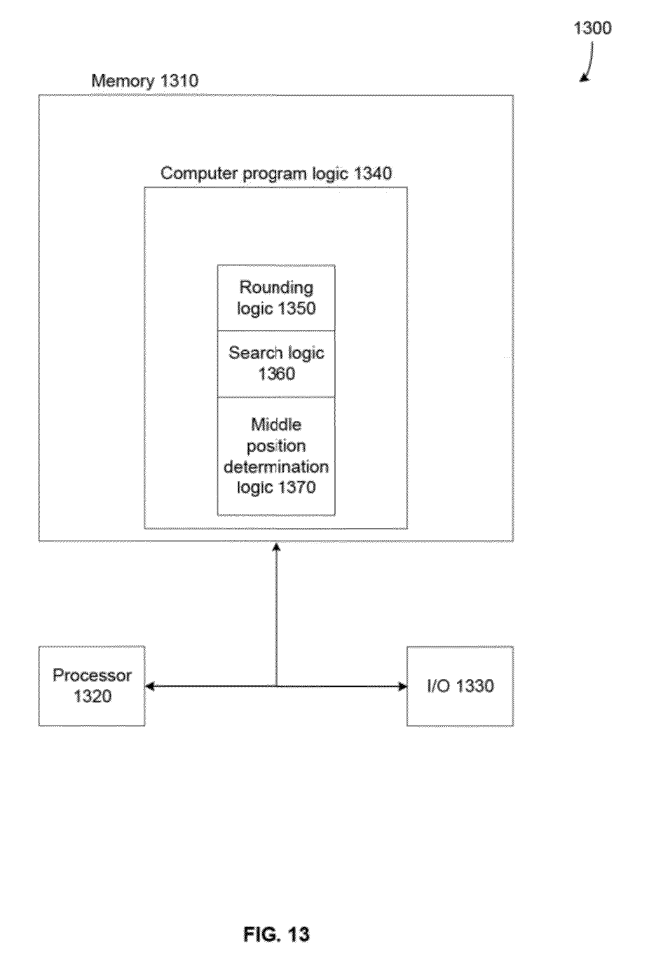

A software or firmware embodiment of the processing described herein is illustrated in FIG. 13. In this figure, system 1300 may include a processor 1320 and a body of memory 1310 that may include one or more computer readable media that may store computer program logic 1340. Memory 1310 may be implemented as a hard disk and drive, a removable media such as a compact disk, a read-only memory (ROM) or random access memory (RAM) device, for example, or some combination thereof. Processor 1320 and memory 1310 may be in communication using any of several technologies known to one of ordinary skill in the art, such as a bus. Computer program logic 1340 contained in memory 1310 may be read and executed by processor 1320. One or more I/O ports and/or I/O devices, shown collectively as I/O 1330, may also be connected to processor 1320 and memory 1310. In an embodiment, system 1300 may be incorporated in a video encoder or decoder.

Computer program logic 1340 may include rounding logic 1350. Rounding logic 1350 may be responsible for taking a candidate MV and rounding it to the nearest integer MV. Computer logic 1340 may also include small area search logic 1360, which may be responsible for searching a localized area around an identified rounded candidate MV, in order to find the best MV in that area. In an embodiment, the best MV may be determined on the basis of a metric such as the SAD. Computer program logic 1340 may also include middle position determination logic 1370. This body of logic may be responsible for determining a middle position integer motion vector, between a lowest-SAD rounded candidate and an integer motion vector with the lowest SAD in a search range. In alternative embodiments, additional logic modules may be used to direct other processes used to derive a motion vector, as would be understood by a person of ordinary skill in the art.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
determining candidate motion vectors (MVs) for a target block to be coded in a current picture;
for each candidate vector, rounding the associated pixel position to the nearest whole pixel, generating rounded candidate MVs; and
determining the rounded candidate MV having the lowest associated sum of absolute differences (SAD),
wherein the method is performed by an appropriately programmed processor in a video decoder.

2. The method of claim 1, further comprising:
using the determined lowest-SAD rounded candidate MV as a final derived MV for video decompression.

3. The method of claim 1, further comprising:
using the candidate MV corresponding to the lowest-SAD rounded candidate MV, as a final derived MV for video decompression.

4. The method of claim 1, further comprising:
performing a search, in a defined range around the lowest-SAD rounded candidate, to find an integer MV with the lowest SAD in the range.

5. The method of claim 4, further comprising:
using the integer MV with the lowest SAD in the range as a final derived MV for video decompression.

6. The method of claim 4, further comprising:
determining a middle position integer MV, between the lowest-SAD rounded candidate MV and the integer MV with the lowest SAD in the range; and
using the determined middle position integer MV as the final derived MV for video decompression.

7. The method of claim 1, wherein the candidate MVs are derived from MVs of coded blocks that spatially neighbor the target block.

8. The method of claim 1, wherein the candidate MVs are derived from MVs of coded blocks that temporally neighbor the target block.

9. A system, comprising:
a processor; and
a memory in communication with said processor, for storing a plurality of processing instructions for directing said processor to:
determine candidate motion vectors (MVs) for a target block to be coded in a current picture;
for each candidate vector, round the associated pixel position to the nearest whole pixel, generating rounded candidate MVs; and
determine the rounded candidate MV having the lowest associated sum of absolute differences (SAD).

10. The system of claim 9, wherein said memory further stores processing instructions for directing said processor to:
use the determined lowest-SAD rounded candidate MV as a final derived MV for video decompression.

11. The system of claim 9, wherein said memory further stores processing instructions for directing said processor to:
use the candidate MV corresponding to the lowest-SAD rounded candidate MV, as a final derived MV for video decompression.

12. The system of claim 9, wherein said memory further stores processing instructions for directing said processor to:
perform a search, in a defined range around the lowest-SAD rounded candidate, to find an integer MV with the lowest SAD in the range.

13. The system of claim 12, wherein said memory further stores processing instructions for directing said processor to:
use the integer MV with the lowest SAD in the range as a final derived MV for video decompression.

14. The system of claim 12, wherein said memory further stores processing instructions for directing said processor to:
determine a middle position integer MV, between the lowest-SAD rounded candidate MV and the integer MV with the lowest SAD in the range; and
use the determined middle position integer MV as the final derived MV for video decompression.

15. The system of claim 9, wherein the candidate MVs are derived from MVs of coded blocks that spatially neighbor the target block.

16. The system of claim 9, wherein the candidate MVs are derived from MVs of coded blocks that temporally neighbor the target block.

17. A computer program product including a non-transitory computer readable medium having computer program logic stored therein, the computer program logic comprising:
logic to cause a processor to determine candidate motion vectors (MVs) for a target block to be coded in a current picture;
logic to cause the processor to round the associated pixel position to the nearest whole pixel for each candidate vector, generating rounded candidate MVs; and
logic to cause the processor to determine the rounded candidate MV having the lowest associated sum of absolute differences (SAD).

18. The computer program product of claim 17, further comprising:
logic to cause the processor to use the determined lowest-SAD rounded candidate MV as a final derived MV for video decompression.

19. The computer program product of claim 17, further comprising:
logic to cause the processor to use the candidate MV corresponding to the lowest-SAD rounded candidate MV, as a final derived MV for video decompression.

20. The computer program product of claim 17, further comprising:
logic to cause the processor to perform a search, in a defined range around the lowest-SAD rounded candidate, to find an integer MV with the lowest SAD in the range.

21. The computer program product of claim 20, further comprising:
logic to cause the processor to use the integer MV with the lowest SAD in the range as a final derived MV for video decompression.

22. The computer program product of claim 20, further comprising:
logic to cause the processor to determine a middle position integer MV, between the lowest-SAD rounded candidate MV and the integer MV with the lowest SAD in the range; and
logic to cause the processor to use the determined middle position integer MV as the final derived MV for video decompression.

23. The computer program product of claim 17, wherein the candidate MVs are derived from MVs of coded blocks that spatially neighbor the target block.

24. The computer program product of claim 17, wherein the candidate MVs are derived from MVs of coded blocks that temporally neighbor the target block.
